(19) United States
(12) Patent Application Publication
(10) Pub. No.: US 2015/0334196 A1
(43) Pub. Date: Nov. 19, 2015

(54) METHOD AND APPARATUS FOR PRESERVING PACKET SWITCHED (PS) SIGNALING CONNECTION

(71) Applicant: Samsung Electronics Co., Ltd., Gyeonggi-do (KR)

(72) Inventors: Bharat Vinayak BHAT, Bangalore (IN); Anand Basavaraj BIRADAR, Bangalore (IN)

(73) Assignee: Samsung Electronics Co., Ltd.

(21) Appl. No.: 14/713,371

(22) Filed: May 15, 2015

(30) Foreign Application Priority Data
May 15, 2014 (IN) 2425/CHE/2014

(51) Int. Cl. H04L 29/08; H04W 76/04

(52) U.S. Cl. CPC H04L 67/142; H04W 76/045

(57) ABSTRACT

Methods and apparatuses are provided for preserving a signaling connection using a UE in a wireless network. An RAU request message is sent from the UE, to at least one network node in the wireless network, when a suspension condition is detected at the UE while the UE is in a connected state. The UE receives a RAU response message from the at least one network node. Activation of a timer is restricted at the UE to preserve the signaling connection in response to receipt of the RAU response message, when at least one radio bearer associated with the UE is detected.

### PRIORITY

This application claims priority under 35 U.S.C. §119(a) to Indian Provisional Application No. 2425/CHE/2014, which was filed on May 15, 2014, and Indian Complete Patent Application No. 2425/CHE/2014, which was filed on Nov. 6, 2014, the contents of which are incorporated herein by reference.

### BACKGROUND

1. Field of the Disclosure

The embodiments relate generally to wireless communication, and more particularly; to the preservation of a Packet Switching (PS) signaling connection during an ongoing PS data session.

2. Description of Related Art

Generally, in a Universal Mobile Telecommunications System (UMTS) network, a Radio Resource Control (RRC) part of a protocol stack is responsible for the assignment, configuration, and release of radio resources between a User Equipment (UE) and a Universal Terrestrial Radio Access Network (UTRAN). The RRC protocol is described in detail in 3^{rd} Generation Partnership Project (3GPP) specification: TS 25.331. When the UE is in an idle mode, the UE is required to request an RRC connection whenever the UE wants to send any user data or in response to a page or whenever the UTRAN or a Serving GPRS Support Node (SGSN) pages the UE to receive data from an external data network, such as, for example, a push server. Upon connecting, the UE is in a UMTS Terrestrial Radio Access (UTRA) connected mode. UE behavior while in the idle and connected modes is described in detail in 3GPP specifications: TS 25.304 and TS 25.331.

PS signaling is utilized in communication networks to transmit and receive data between devices, such as, for example, between UEs and various network devices. In order to utilize a PS signaling scheme, a PS signaling connection is obtained between the UE and the network. In order to obtain the PS signaling connection, a session establishment procedure is initiated between the UE and the network. For example, a session establishment procedure can be a network initiated paging procedure or the UE initiated service request procedure.

Technical specifications of 3GPP and, in particular, 3GPP TS 24.008, REL 6 and REL 7A describe an approach for either maintaining or releasing the PS signaling connection following General Packet Radio Service (GPRS) attach and Routing Area Update (RAU) procedures. In this regard, 3rd generation (3G) networks use a Follow on Proceed (FOP) bit in the attach result and update result information to indicate whether the PS signaling connection should be maintained or released. If a FOP mode is selected, such as in instances when PS signaling is anticipated, the PS signaling connection will remain open following the GPRS attach and RAU procedures. With the PS signaling connection open, network resource consumption that is required to close the connection is avoided. However, if the FOP bit is set in a No FOP mode, such as in instances when the PS signaling is not anticipated, the connection between the UE and the network is automatically released. In this mode, a timer, referred to as T3340 in the 3GPP specification, is set, and the PS signaling connection remains open until the timer expires. When the timer expires, for example, after ten seconds, the UE notifies the network's RRC, and the RRC releases the PS signaling connection using a Signaling Connection Release Indication (SCRI).

When Radio Access Bearers (RABs) are established successfully and the GPRS Mobility Management (GMM) functional state is in a Packet Mobile Management connected (i.e., PMM_CONNECTED) state while the PS data session is ongoing, the UE performs the RAU due to any of the conditions specified in 24.008 section 4.7.5. Upon successful completion of the RAU without an “FOP” grant from the network, the UE starts the timer, T3340. Upon expiration of the timer, the UE automatically initiates a SCRI towards the network, and the network releases the PS signaling connection, as shown in the FIG. 1A.

In another scenario, the UE performs the RAU due to any of the conditions specified in 24.008 section 4.7.5. During the RAU procedure, the user plane radio bearers may be established between the UE and the RAN. Upon successful completion of the RAU without an “FOP” grant from the network, the UE starts the timer, T3340. Upon expiration of the timer, the UE automatically initiates the SCRI towards the network, and the network releases the PS signaling connection, as shown in the FIG. 1B.

When the UE performs SCRI, the SGSN may use (as an implementation option), the FOP indication to release or keep the Iu connection after the completion of the RAU procedure. However, it is not guaranteed that the SGSN will always indicate FOP if the radio bearer exists with reference to the UE. Therefore, even when an RAB is established and a PS data session is ongoing, the UE may request a PS signaling connection release due to expiration of the timer. Accordingly, the release and reestablishment procedures unnecessarily utilize resources of both the UE and the network, and may impair the end user's experience or quality of service due to potentially increased latency in data transfer.

### SUMMARY

Embodiments have been made to address at least the above problems and/or disadvantages and to provide at least the advantages described below. Accordingly, an aspect of the embodiments provides a method and system for preserving a signaling connection using a UE in a wireless network.

Another aspect of the embodiments provides a method to restrict activation of a timer at the UE to preserve the signaling connection in response to receipt of an RAU response message when a radio bearer associated with the UE is detected.

According to one an embodiment, a method is provided for preserving a signaling connection using a UE in a wireless network. An RAU request message is sent from the UE, to at least one network node in the wireless network, when a suspension condition is detected at the UE while the UE is in a connected state. The UE receives a RAU response message from the at least one network node. Activation of a timer is restricted at the UE to preserve the signaling connection in response to receipt of the RAU response message, when at least one radio bearer associated with the UE is detected.

According to another embodiment, a UE is provided for preserving a signaling connection in a wireless network. The UE includes a memory, and a transmitter configured to send a RAU message to at least one network node in the wireless network when a suspension condition is detected while the UE is in a connected state. The UE also includes a receiver configured to receive a RAU response message from the at least one network node. The UE further includes a processor configured to restrict activation of a timer at the UE to preserve the signaling connection in response to receipt of the RAU response message, when at least one radio bearer associated with the UE is detected.

According to another embodiment, an article of manufacture is provided for preserving a signaling connection in a wireless network. The article of manufacture includes a non-transitory machine readable medium containing one or more programs which when executed implement the steps of: sending an RAU request message to at least one network node in the wireless network, when a suspension condition is detected while in a connected state; receiving an RAU response message from the at least one network node; and restricting activation of a timer to preserve the signaling connection in response to receipt of the RAU response message, when at least one radio bearer associated is detected.

### BRIEF DESCRIPTION OF THE DRAWINGS

The above and other aspects, features, and advantages of the embodiments will be more apparent from the following detailed description when taken in conjunction with the accompanying drawings, in which:

FIGS. 1A and 1B are diagrams illustrating performance of a PS signaling connection release during an ongoing PS data session;

FIG. 2 is a diagram illustrating a system for preserving a signaling connection using a UE in a wireless network, according to an embodiment disclosed herein;

FIG. 3 is a diagram illustrating modules available in a UE for preserving a signaling connection, according to an embodiment disclosed herein;

FIG. 4 is a diagram illustrating preservation of a signaling connection using a UE in a wireless network, according to an embodiment disclosed herein;

FIG. 5 is a diagram illustrating preservation of a signaling connection using a UE in a wireless network, according to another embodiment disclosed herein;

FIG. 6 is a flow diagram illustrating a method for preserving a signaling connection using a UE in a wireless network, according to an embodiment disclosed herein;

FIG. 7 is a flow diagram illustrating a method for preserving a signaling connection using a UE in a wireless network, according to an embodiment disclosed herein; and

FIG. 8 is a diagram illustrating a computing environment for implementing the method and system for preserving a signaling connection using a UE in a wireless network, according to an embodiment disclosed herein.

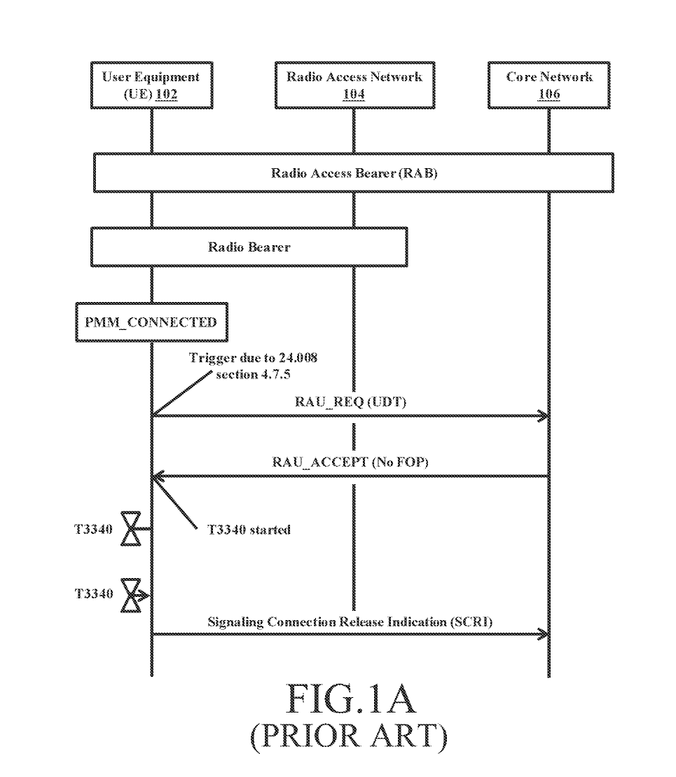

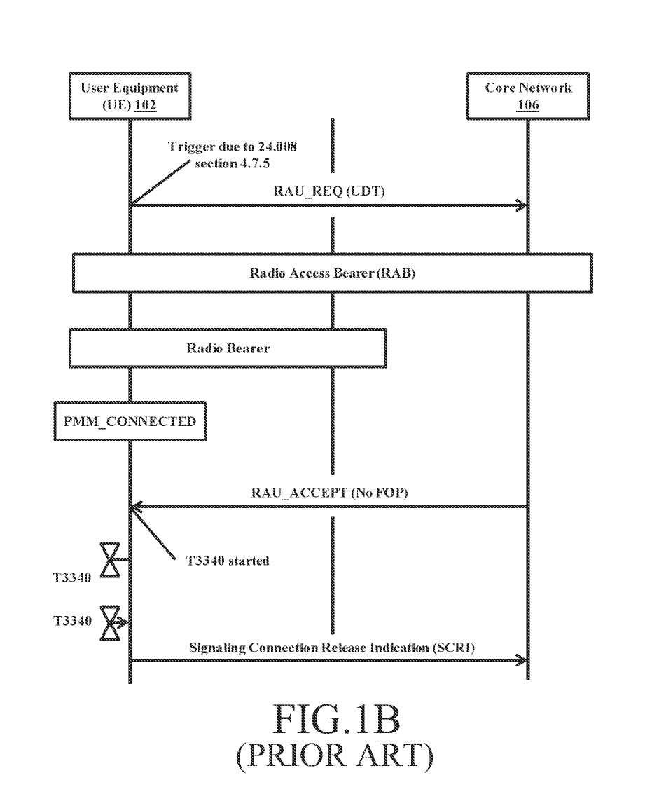

### DETAILED DESCRIPTION

Embodiments are described in detail with reference to the accompanying drawings. The same or similar components may be designated by the same or similar reference numerals although they are illustrated in different drawings. Detailed descriptions of constructions or processes known in the art may be omitted to avoid obscuring the subject matter described herein.

The terms “an”, “one”, and “some”, as used herein, do not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising”, when used herein, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as that commonly understood by one of ordinary skill in the art to which this disclosure pertains. It will be further understood that terms, such as those defined in commonly used dictionaries, should be interpreted as having a meaning that is consistent with their meaning in the context of the relevant art, and will not be interpreted in an idealized or overly formal sense unless expressly so defined herein.

The embodiments herein disclose a method and system for preserving a signaling connection using a UE in a wireless network. In an embodiment, the signaling connection is a PS signaling connection. The UE may send a RAU request message to a network node in the wireless network after detecting a suspension condition, when the UE is in a Packet Mobile Management connected (i.e., PMM_CONNECTED) state. In an embodiment, the network node can be a Serving GPRS Support Node (SGSN) in a core network. Further, the UE receives a RAU response message from the network node and restricts activation of a timer in order to preserve the signaling connection, in response to receipt of the RAU response message, when a radio bearer associated with the UE is detected. In an embodiment, the RAU response message can include a RAU ACCEPT message. In another embodiment, the RAU response message can include a Follow on Proceed (FOP) or a No FOP indication. The timer can be embodied as, but is not limited to, a T3340.

The method and system described herein is simple and robust for preserving a PS signaling connection release during an ongoing PS data session, when the UE's GPRS Mobility Management (GMM) functional state is in the PMM_CONNECTED state and a radio bearer exists; thereby, avoiding unnecessary session establishment procedures.

For example, when a PS signaling session is established between the UE and the RAN, the UE will be in a PMM_CONNECTED state. If the UE moves from an existing routing area to another routing area, the UE triggers the sending of a RAU request message to the network. Upon receiving the RAU request message, the network sends the RAU ACCEPT message to the UE. The UE then determines whether a radio bearer associated with the UE is detected. Upon detecting the radio bearer, the UE restricts activation of the T3340 to preserve the ongoing data transfer session and the PS signaling connection.

In conventional systems, when the network indicates a No FOP grant in the RAU response message, the T3340 is started. After the expiry of the T3340, the UE sends the SCRI to the network and the network releases the PS signaling connection. Here, even if there is an established RAB and a PS data session ongoing, the UE requests PS signaling connection release due to expiration of the T3340. The release and reestablishment procedures unnecessarily utilize resources of both the UE and the network, and may impair the end user's experience or quality of service due to potentially increased latency in data transfer. Each session establishment procedure can consume network resources and, as such, avoiding unnecessary session establishment procedures is desirable. Accordingly, it is advantageous to provide an improved mechanism for avoiding unnecessary release and reestablishment procedures by maintaining an open PS signaling connection in certain circumstances including, for example, when additional PS signals are transmitted following the reception of a No FOP indication.

Unlike conventional systems, the activation of the T3340 at the UE, in embodiments described herein, is restricted to preserve a PS signaling connection when a radio bearer associated with the UE is detected. The PS signaling connection release, the consumption of the network resources, and the unnecessary session establishment procedures are avoided.

The terms “Network Node” and “SGSN” are used interchangeably herein.

The terms “Signaling Connection” and “PS Signaling Connection” are used interchangeably herein.

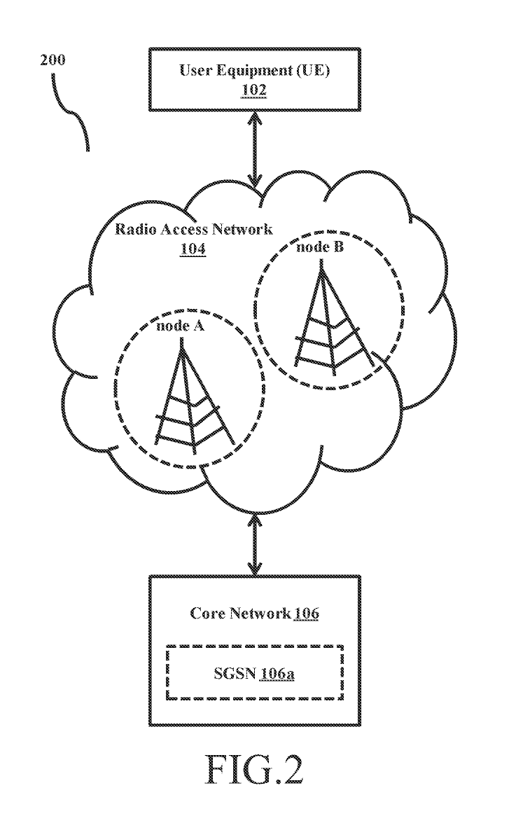

FIG. 2 is a diagram illustrating a system for preserving a signaling connection using a UE in a wireless network, according to an embodiment disclosed herein. In an embodiment, a system 200 is configured to include a UE 102, a Radio Access Network (RAN) 104, and a core network 106.

The UE 102, as described herein, may be embodied as, but is not limited to, a mobile phone, a mobile station, a smart phone, a Personal Digital Assistants (PDAs), a tablet, a phablet, or any other electronic device. The UE 102 can communicate with the core network 106 through the RAN 104. Through the core network 106, the UE 102 can be connected with external networks, such as the Internet.

In an embodiment, if an RAB is activated on the UE 102, then the UE 102 will be transmitting data over the RAB, which will define the characteristics of the data transfer. Upon activating the RAB, the UE 102 moves to the PMM_CONNECTED state. The UE 102 may send the RAU request message to an SGSN 106a in the core network 106 after detecting a suspension condition. In an embodiment, the suspension condition can be one of the conditions specified in 24.008 section 4.7.5.

The RAN 104, as described herein, may be embodied as, but is not limited to, a GSM Radio Access Network (GRAN), a GSM EDGE Radio Access Network (GERAN), a UMTS Radio Access Network (UTRAN), or any other network. The RAN 104 includes a plurality of access points that serve the UE 102 over air interfaces. The access points in the RAN 104 may be referred to as Access Nodes (ANs), Access Points (APs), Base Stations (BSs), Node Bs, and so on. As shown FIG. 2, the RAN 104 includes node A and node B, which are coupled to a Radio Network Controller (RNC) over a wired backhaul interface. The RNC is responsible for signaling, establishing, and tearing down bearer channels (i.e., data channels) between the SGSN 106a in the core network 106 and the UE 102 served by the RAN 104. The RAN 104 is configured to connect to the core network 106, which can mediate an exchange of the PS data with external networks, such as the Internet. For example, in the UMTS architecture, an access network can be controlled by the RNC, which is connected to the core network 106 and provides access to the core network 106, i.e., serves as an AN. In 3GPP specification: 3G TS 25.415 V3.2.0, the interface between the AN and a node in the core network is denoted as an Iu interface. Over the Iu interface, connections can be established according to an Iu user plane protocol.

The core network 106 includes the SGSN 106a. The SGSN 106a is responsible for the delivery of data packets to and from the UE 102 within an associated geographical service area. The tasks of the SGSN 106a include packet routing and transfer, mobility management (e.g., attach/detach and location management), logical link management, and authentication and charging functions. The location register of the SGSN 106a stores location information (e.g., current cell, current VLR) and user profiles (e.g., IMSI, PDP address used in the packet data network) of all GPRS users registered with the SGSN 106a.

The UE 102 receives a RAU response message from the SGSN 106a. In an embodiment, the RAU response message can include a RAU ACCEPT message. In another embodiment, the RAU response message also includes a FOP indication or a No FOP indication. For example, the UE 102 may receive the RAU ACCEPT message along with the No FOP indication from the SGSN 106a. Upon receiving the RAU response message, the UE 102 can be configured to determine whether a radio bearer associated with the UE 102 is detected. The UE 102 can be configured to restrict activation of the timer to preserve the PS signaling connection after detecting the radio bearer.

In an embodiment, in the Iu mode, the SGSN 106a in the core network 106 may preserve the signaling connection, if the UE 102 indicates the follow-on request pending in the RAU request message. The SGSN 106a may also prolong the signaling connection without receiving any indication from the UE 102, if the user plane RABs have been established for the UE 102. Further, if the SGSN 106a wants to preserve the signaling connection (i.e., if the UE has indicated “follow-on request pending” in the RAU request message or if the user plane RABs have been established for the UE), the SGSN 106a may indicate the FOP in the RAU response message. If the SGSN 106a wishes to release the signaling connection, the SGSN 106a indicates “no FOP” in the RAU response message.

For example, when a data transfer is ongoing and the UE is in the PMM_CONNECTED state, if the UE moves from an existing routing area to another routing area, the UE will initiate transmitting the RAU request message to the network. Also, the UE will not set any follow on request because there is no pending request from the UE. Upon receiving the RAU request message, the network sends an RAU ACCEPT message to the UE. The UE determines if any RABs are activated before performing the RAU procedure. Upon receiving the RAU response message, the UE will not start the timer so that the release of the ongoing data transfer session and the PS signaling connection is avoided.

FIG. 2 illustrates an overview of the system 200, however, a person of ordinary skill in the art would recognize that embodiments are not limited thereto. Further, the system 200 can include different hardware or software components communicating among each other.

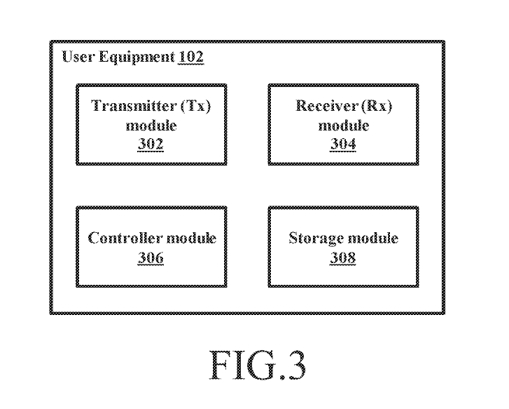

FIG. 3 is a diagram illustrating modules available in a UE for preserving a signaling connection, according to an embodiment disclosed herein. In an embodiment, the UE 102 is configured to include a transmitter (Tx) module 302, a receiver (Rx) module 304, a controller module 306, and a storage module 308.

The Tx module 302 sends the RAU request message to the SGSN 106a of the core network 106 after detecting the suspension condition when the UE 102 is in the PMM_CONNECTED state. The Rx module 304 receives the RAU response message from the SGSN 106a. Further, the Rx module 304 sends the received RAU response message associated with the UE 102 to the controller module 306. In an embodiment, the RAU response message can include a RAU ACCEPT message. In another embodiment, the RAU response message also includes a Follow on Proceed (FOP) indication or a No FOP indication.

Upon receiving the RAU response message, the controller module 306 can be configured to determine whether the radio bearer associated with the UE 102 is detected. Further, the controller module 306 can be configured to restrict activation of the timer at the UE 102 in order to preserve the PS signaling connection after detecting the existence of the radio bearer associated with the UE 102, thereby avoiding the release of the ongoing data transfer session. The storage module 308 can be configured to store control instructions to perform various operation in the system 200.

FIG. 3 illustrates an overview of the UE 102, however the embodiment are not limited thereto. Further, the UE 102 can include any number of modules communicating among each other along with the other components of the system 200.

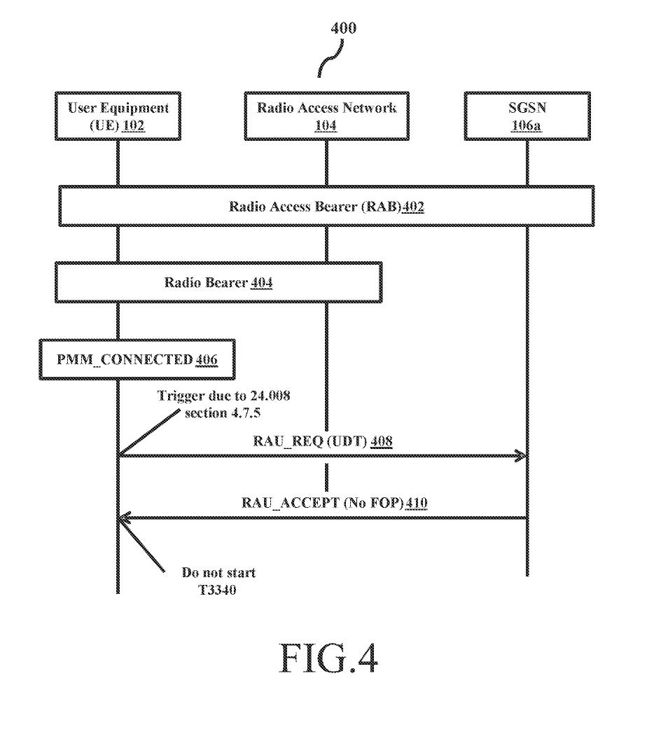

FIG. 4 is a diagram illustrating preservation of a signaling connection using a UE in a wireless network, according to an embodiment disclosed herein. In an embodiment, a signaling sequence 400 depicts communications between the UE 102 and the SGSN 106a. In step 402, the UE 102 sends the RAB request to the SGSN 106a for establishing the PS signaling connection to initiate data transfer. The RAN 104 assigns the radio bearer for the UE 102 for receiving and transmitting data from the SGSN 106a, in step 404. For example, the node A or the node B in the RAN 104 may assign the radio bearer to the UE 102. in step 406, the UE 102 moves to the PMM_CONNECTED state after receiving the radio bearer. The UE 102 sends the RAU request to the SGSN 106a in response to detecting a suspension condition, in step 408. In an embodiment, the suspension condition can be the conditions specified in 24.008 section 4.7.5.

The SGSN 106a sends the RAU response message to the UE 102, in step 410. For example, the UE 102 may receive the RAU ACCEPT message along with the No FOP indication from the SGSN 106a. In another example, the UE 102 may receive the RAU ACCEPT message along with the No FOP indication from the SGSN 106a. Further, the UE 102 determines whether the radio bearer is detected. The UE 102 restricts activation of the timer to preserve the signaling connection during an ongoing PS session, after detecting the radio bearer associated with the UE 102.

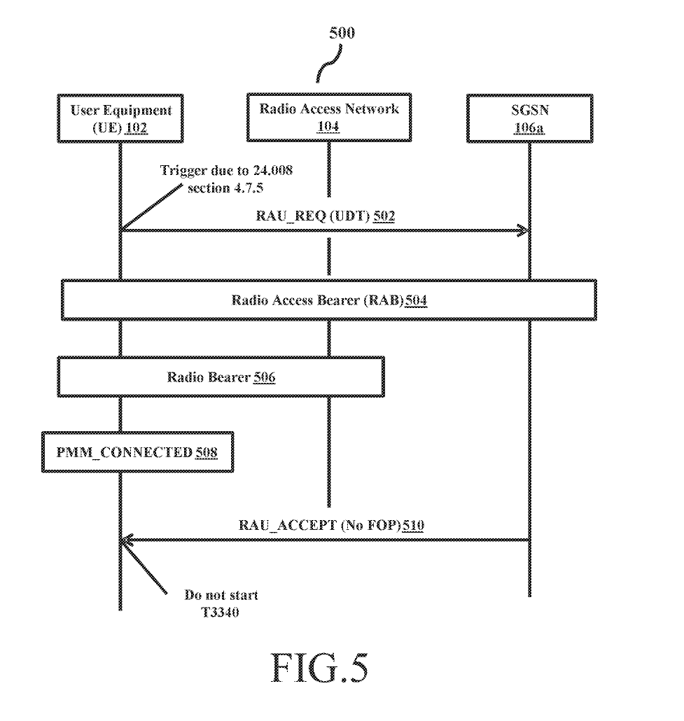

FIG. 5 is a diagram illustrating preservation of a signaling connection using a UE in a wireless network, according to an embodiment disclosed herein. In an embodiment, a signaling sequence 500 depicts communications between the UE 102 and the SGSN 106a. In step 502, the UE 102 sends the RAU request to the SGSN 106a in response to detecting a suspension condition. In an embodiment, the suspension condition can be one of the conditions specified in 24.008 section 4.7.5. The UE 102 establishes the RAB, in step 504. In step 506, the RAN 104 assigns the radio bearer for the UE 102 for receiving and transmitting data from the SGSN 106a. For example, the node A or the node B in the RAN 104 may assign the radio bearer to the UE 102.

Upon receipt of the RAU request, the SGSN 106a sends the RAU response message to the UE 102, in step 510. For example, the UE 102 may receive the RAU ACCEPT message along with No FOP indication from the SGSN 106a. The UE 102 determines whether the radio bearer is detected. Further, the UE 102 restricts activation of the timer to preserve the signaling connection during an ongoing PS session, after detecting the radio bearer associated with the UE 102.

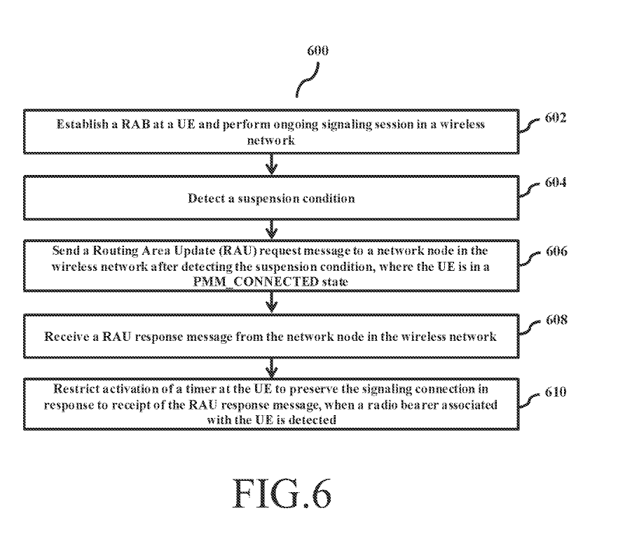

FIG. 6 is a flow diagram illustrating a method for preserving a signaling connection using a UE in a wireless network, according to an embodiment disclosed herein. In step 602 of a method 600, the controller module 306 establishes the RAB at the UE and performs an ongoing signaling session in the wireless network. In an embodiment, the signaling session is the PS signaling session. In step 604, a suspension condition is detected by the controller module 306. In an embodiment, the suspension condition is one of the conditions specified in 24.008 section 4.7.5.

In step 606, the Tx module 302 sends the RAU request message to the network node in the wireless network, after detecting the suspension condition while the UE is in the PMM_CONNECTED state. In step 608, the Rx module 304 receives the RAU response message from the network node in the wireless network. In an embodiment, the RAU response message includes a RAU ACCEPT message. In another embodiment, the RAU response message also includes the FOP indication or the No FOP indication.

In step 610, the controller module 306 restricts activation of the timer at the UE to preserve the signaling connection in response to receipt of the RAU response message, when the radio bearer associated with the UE is detected. In an embodiment, the timer is the T3340 timer.

The various actions, acts, blocks, steps, and the like in the method 600 may be performed in the order presented, in a different order, or simultaneously. Further, in embodiments, some actions, acts, blocks, steps, and the like may be omitted, added, modified, skipped, and the like without departing from the scope of the embodiments.

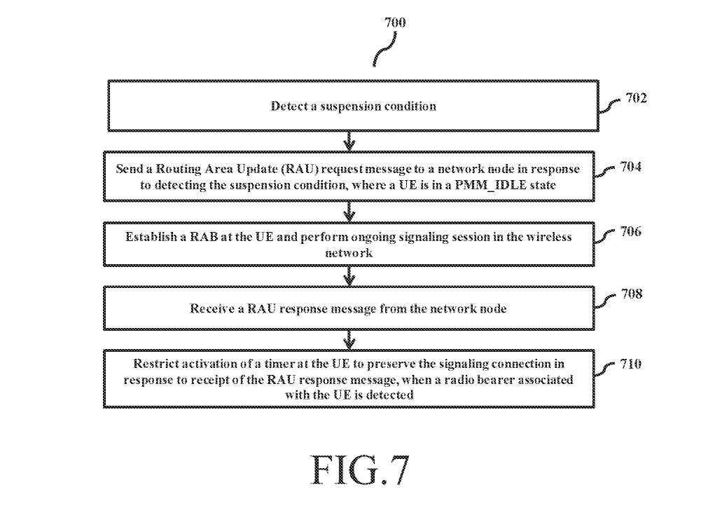

FIG. 7 is a flow diagram illustrating a method for preserving a signaling connection using a UE in a wireless network, according to an embodiment disclosed herein. In step 702 of a method 700, the controller module 306 detects a suspension condition. In step 704, the Tx module 302 sends the RAU request message to the network node after detecting the suspension condition, while the UE is in the PMM_IDLE state. In an embodiment, the suspension condition is one of the conditions specified in 24.008 section 4.7.5. In step 706, the controller module 306 establishes the RAB at the UE and performs an ongoing signaling session. In an embodiment, the signaling session is the PS signaling session.

In step 708, the Rx module 304 receives the RAU response message from the network node in the wireless network. In an embodiment, the RAU response message includes the RAU ACCEPT message. In another embodiment, the RAU response message also includes the FOP indication or the No FOP indication. In step 710, the controller module 306 restricts activation of the timer at the UE to preserve the signaling connection in response to receipt of the RAU response message when the radio bearer associated with the UE is detected. In an embodiment, the timer is the T3340.

The various actions, acts, blocks, steps, and the like in the method 700 may be performed in the order presented, in a different order, or simultaneously. Further, in some embodiments, some actions, acts, blocks, steps, and the like may be omitted, added, modified, skipped, and the like without departing from the scope of the embodiments.

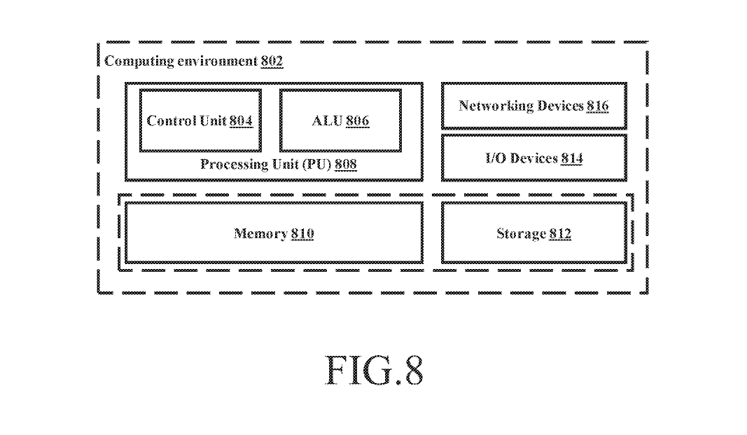

FIG. 8 is a diagram illustrating a computing environment implementing the method and system for preserving a signaling connection using a UE in a wireless network, according to an embodiment disclosed herein. As shown in FIG. 8, a computing environment 802 includes at least one processing unit 808, which is equipped with a control unit 804 and an Arithmetic Logic Unit (ALU) 806, a memory 810, a storage unit 812, a plurality of networking devices 816, and a plurality Input/Output (I/O) devices 814. The processing unit 808 is responsible for processing the instructions of the algorithm. The processing unit 808 receives commands from the control unit in order to perform processing. Further, any logical and arithmetic operations involved in the execution of the instructions are computed with the help of the ALU 806.

The overall computing environment 802 can be composed of multiple homogeneous and/or heterogeneous cores, multiple Central Processing Units (CPUs) of different kinds, special media, and other accelerators. The processing unit 808 is responsible for processing the instructions of the algorithm. Further, a plurality of processing units 808 may be located on a single chip or over multiple chips.

The algorithm, which includes instructions and codes required for the implementation, is stored in the memory unit 810, the storage 812, or both. At the time of execution, the instructions may be fetched from the corresponding memory 810 and/or the storage 812, and executed by the processing unit 808.

For hardware implementations, various networking devices 816 or external I/O devices 814 may be connected to the computing environment to support the implementation through a networking unit and an I/O device unit.

The embodiments disclosed herein may be implemented through at least one software program running on at least one hardware device and performing network management functions to control the elements. The elements shown in FIGS. 2, 3, 4, 5, and 8 include blocks which can be embodied as at least one of a hardware device, or a combination of a hardware device and a software module.

The various devices, modules, and the like described herein may be enabled and operated using hardware circuitry, for example, complementary metal oxide semiconductor based logic circuitry, firmware, software and/or any combination of hardware, firmware, and/or software embodied in a machine readable medium.

While embodiments have been shown and described herein, it will be understood by those skilled in the art that various changes in form and detail may be made therein without departing from the spirit and scope of the embodiments as defined by the appended claims.

What is claimed is:

1. A method for preserving a signaling connection using a User Equipment (UE) in a wireless network, the method comprising the steps of:
sending a Routing Area Update (RAU) request message, from the UE, to at least one network node in the wireless network, when a suspension condition is detected at the UE while the UE is in a connected state;
receiving, at the UE, an RAU response message from the at least one network node; and
restricting activation of a timer at the UE to preserve the signaling connection in response to receipt of the RAU response message, when at least one radio bearer associated with the UE is detected.

2. The method of claim 1, wherein the signaling connection is a Packet Switched (PS) signaling connection.

3. The method of claim 1, wherein the timer is a T3340.

4. The method of claim 1, wherein the RAU response message is an RAU ACCEPT message comprising one of a Follow on Proceed (FOP) indication and a No FOP indication.

5. The method of claim 1, wherein the connected state is a Packet Mobility Management connected (PMM_Connected) state.

6. A User Equipment (UE) for preserving a signaling connection in a wireless network comprising a controller, the UE comprising:
a memory;
a transmitter configured to send a Routing Area Update (RAU) message to at least one network node in the wireless network when a suspension condition is detected while the UE is in a connected state;
a receiver configured to receive an RAU response message from the at least one network node; and
a processor configured to restrict activation of a timer at the UE to preserve the signaling connection in response to receipt of the RAU response message, when at least one radio bearer associated with the UE is detected.

7. The UE of claim 6, wherein the signaling connection is a Packet Switched (PS) signaling connection.

8. The UE of claim 6, wherein the timer is a T3340.

9. The UE of claim 6, wherein the RAU response message is an RAU ACCEPT message comprising one of a Follow on Proceed (FOP) indication and a No FOP indication.

10. The UE of claim 6, wherein the connected state is a Packet Mobility Management connected (PMM_Connected) state.

11. An article of manufacture for preserving a signaling connection in a wireless network, comprising a non-transitory machine readable medium containing one or more programs which when executed implement the steps of:
sending a Routing Area Update (RAU) request message to at least one network node in the wireless network, when a suspension condition is detected while in a connected state;
receiving an RAU response message from the at least one network node; and
restricting activation of a timer to preserve the signaling connection in response to receipt of the RAU response message, when at least one radio bearer is detected.
